(19) United States
(12) Patent Application Publication
(10) Pub. No.: US 2025/0305872 A1
(43) Pub. Date: Oct. 2, 2025

(54) UPCONVERTING IMAGE SENSOR WITH PUMP SOURCE

(71) Applicant: SRI International, Menlo Park, CA (US)

(72) Inventors: Peter Alan Levine, West Windsor, NJ (US); Namwoong Paik, Lawrenceville, NJ (US); Arel Weisberg, East Brunswick Township, NJ (US)

(21) Appl. No.: 19/094,317

(22) Filed: Mar. 28, 2025

Related U.S. Application Data
(60) Provisional application No. 63/571,917, filed on Mar. 29, 2024.

(51) Int. Cl. G01J 1/58

(52) U.S. Cl. CPC G01J 1/58

(57) ABSTRACT

An example sensor includes an upconversion layer comprising a plurality of crystals configured to convert electromagnetic radiation comprising a first range of wavelengths greater than 1100 nm to electromagnetic radiation comprising a second range of wavelengths less than or equal to 1100 nm. The sensor also includes a photo-sensitive silicon substrate configured to detect the electromagnetic radiation comprising the second range of wavelengths. The sensor also includes a light source configured to emit electromagnetic radiation comprising the first range of wavelengths to the upconversion layer.

This application claims the benefit of U.S. Provisional Patent Application 63/571,917, filed Mar. 29, 2024, the entire content of which is incorporated herein by reference.

### TECHNICAL FIELD

This disclosure generally relates to image sensors.

### BACKGROUND

An image sensor may be a semiconductor device for converting an optical image into electric signals. The image sensor may include a photo-sensitive silicon element capable of detecting light in the ultraviolet (UV), visible, and/or near infrared (NIR, e.g., up to about 1100 nanometers (nm)) wavelength ranges. Image sensors configured to detect light having wavelengths greater than 1100 nm, e.g., short wave infrared (SWIR), mid-wave infrared (MWIR), and/or long wave infrared (LWIR) are typically expensive due to the need to use materials and/or techniques capable of detecting the lower energy light, e.g., indium gallium arsenide (InGaAs), mercury cadmium telluride (HgCdTe), germanium, lead sulfide (PbS), indium antimonide (InSb), indium arsenide (InAs), lead selenide, lithium tantalate (LiTaO3), platinum silicide (PtSi), microbolometers, photomultiplier tubes, and the like.

### SUMMARY

In general, this disclosure describes example techniques for a sensor including an upconversion layer and an optical pump to increase gain and sensitivity for a signal, e.g., an electromagnetic (EM) radiation signal, upconverted by the upconversion layer. Upconversion layers for upconverting EM radiation may use rare-earth element doped crystals, and conversion efficiencies of rare-earth element doped crystals may typically range from 1% to 10% depending on the quality of the crystals and environmental conditions, as well as the amount of incident EM radiation being upconverted, e.g., for detection by a detector. For low amounts of incident EM radiation, e.g., low light conditions and without an optical pump, the conversion efficiency of the upconversion layer is relatively low, e.g., about 1% or less.

For example, the doped crystals may convert lower energy light (e.g., the longer wavelength incident EM radiation) to higher energy light by way of a multi-photon conversion process in which multiple photons of the longer wavelength light being detected are absorbed by atoms of the dopant and excite atoms of the dopant to a higher energy state, e.g., from a lower or ground state. The atoms of the dopant may then decay to the lower or ground state via spontaneous emission of a single photon of the shorter wavelength of light, e.g., a photon within the frequency and/or wavelength range that the photo-sensitive silicon substate can absorb and detect. For low incident light levels, the population of dopant atoms excited to a metastable intermediate energy state by absorption of a first photon may be relatively low such that a second photon may not arrive within the decay time of the intermediate state in order to excite the dopant atoms to the final higher energy state, reducing the nominal conversion efficiency of the upconverting layer.

The example techniques described in this disclosure may increase the conversion efficiency of an upconverting layer in low light conditions. An upconversion layer may increase a frequency of incident EM radiation (e.g., incident light) that is incident on the upconversion layer to a frequency range detectable by a photo-sensitive silicon substrate of the sensor. That is, the upconversion layer may upconvert incoming light having a wavelength range not detectable by silicon to a wavelength range that is detectable by silicon. In some examples, the upconversion layer includes crystals comprising a dopant selected to absorb incident EM radiation having first range of relatively higher wavelengths, e.g., wavelengths that are higher than an 1100 nm detection cutoff wavelength for silicon-based detectors (which corresponds to range of relatively lower frequency and energy EM radiation) and to emit electromagnetic radiation having a second range of relatively lower wavelengths, e.g., less than or equal to 1100 nm (which corresponds to range of relatively higher frequency and energy EM radiation). The example techniques described in this disclosure include an optical pump configured to increase the conversion efficiency of the upconversion layer.

For example, a sensor may include an upconverting layer, a photo-sensitive silicon substrate, and an optical pump such as a light source configured to emit light to the upconverting layer. The light source may be configured to emit light within the first range of wavelengths greater than 1100 nm to be incident on the upconverting layer, which may increase the population of atoms of the upconverting layer excited to the intermediate energy state (e.g., “pumping” the atoms to the intermediate state) thereby increasing a probability that a signal photon from a scene, the signal photon having the first range of wavelengths greater than 1100 nm, further excites an atom of the upconversion layer to an energy state, e.g., a final energy state, from which a photon having the second range of wavelengths less than or equal to 1100 nm may be emitted. The conversion efficiency of the upconversion layer may be increased by increasing number of signal photons absorbed that further excite the atoms from the intermediate energy state to the final energy state and that result in emission of a photon having a wavelength within the second range of wavelengths less than or equal to 1100 nm, rather than those signal photons being absorbed and exciting the atoms from the ground state to the intermediate state and then decaying from the intermediate state, e.g., before another signal photon arrives, such as may occur for low amounts of signal light. In some examples, the wavelength and/or wavelength range of the light source may be tunable, and the level and/or amount of light from the light source incident on the upconversion layer may be tunable.

Accordingly, the systems, and techniques disclosed herein may provide one or more technical advantages that realize at least one practical application. For example, the systems and techniques may improve the conversion efficiency of the upconversion layer, and improve the sensitivity of the sensor in low light conditions, e.g., by utilizing and optical pump that is not part of the scene being detected by the sensor. In some examples, the sensor may be implemented as a short-wave infrared sensor configured to sense 1550 nm light, or 2000 nm light, or 2600 nm light, as a sensor of a Light Detection And Ranging (LiDAR) system, and the sensor may improve the distance-sensing range of the LiDAR system. In some examples, systems and techniques may provide an increased distance range by a factor of 2 or greater for direct view or reflected SWIR laser light. In some examples, the systems and techniques may reduce the cost and/or improve the sensitivity of a SWIR sensor and/or LiDAR system low light conditions, e.g., by enabling the use of silicon as a photo-sensitive substrate, such as complementary metal-oxide semiconductor (CMOS) or charge coupled device (CCD) sensors. In some examples, increasing the sensitivity of the sensor results in an increased range of distances capable of being measured, particularly in low-light level conditions. In other words, the systems and techniques described herein may provide a lower cost, silicon-based sensor configured to sense electromagnetic radiation wavelength ranges not otherwise detectable using a photo-sensitive silicon substrate for otherwise not detectable levels of light and/or distance ranges.

In an example, a sensor includes: an upconversion layer including a plurality of crystals configured to convert electromagnetic radiation including a first range of wavelengths greater than 1100 nm to electromagnetic radiation including a second range of wavelengths less than or equal to 1100 nm; a photo-sensitive silicon substrate configured to detect the electromagnetic radiation including the second range of wavelengths; and a light source configured to emit electromagnetic radiation including the first range of wavelengths to the upconversion layer.

In another example, a method of making a sensor includes: positioning an upconversion layer adjacent to a surface of a photo-sensitive silicon substrate, wherein the upconversion layer includes a plurality of crystals, wherein the plurality of crystals are configured to convert electromagnetic radiation including a first range of wavelengths greater than 1100 nm to electromagnetic radiation including a second range of wavelengths less than or equal to 1100 nm, wherein the photo-sensitive silicon substrate is configured to detect the electromagnetic radiation including the second range of wavelengths; and positioning a light source to emit electromagnetic radiation including the first range of wavelengths to the upconversion layer, wherein the light source is positioned to not obstruct a clear aperture of the sensor from receiving electromagnetic radiation including a first range of wavelengths from a scene external to the sensor.

In another example, a method of detecting electromagnetic radiation includes: irradiating, by a light source, an upconversion layer of a sensor with a first electromagnetic radiation comprising a first range of wavelengths greater than 1100 nm; converting, by the upconversion layer, a second electromagnetic radiation comprising the first range of wavelengths and incident on the upconversion layer from a scene external to the sensor to electromagnetic radiation comprising the second range of wavelengths; and detecting, by a photo-sensitive silicon substrate of the sensor, the electromagnetic radiation comprising the second range of wavelengths.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a cross-sectional block diagram illustrating a system including an example sensor in a first illuminated configuration, in accordance with techniques of the disclosure.

FIG. 1B is a cross-sectional block diagram illustrating a system including an example sensor in a second illuminated configuration, in accordance with techniques of the disclosure.

FIG. 2A is a cross-sectional block diagram illustrating the example sensor of FIG. 1A, in accordance with techniques of the disclosure.

FIG. 2B is an illustration of an example energy diagram of an atom of a crystal of an upconversion layer, in accordance with techniques of the disclosure.

FIG. 3 is an example plot illustrating the mean signal per pixel received by an example sensor as a function of the amount of signal light, in accordance with techniques of the present disclosure.

FIG. 4 is a cross-sectional diagram and block diagram illustrating an example system, in accordance with techniques of the disclosure.

FIG. 5 is an example plot illustrating detection light increase as a function of light source driving current for a particular amount of signal light, in accordance with techniques of the present disclosure.

FIG. 6 is an example plot illustrating signal light gain ratio as a function of the amount of signal light, in accordance with techniques of the present disclosure.

FIG. 7 is a flowchart of an example method of making a sensor, in accordance with techniques of the disclosure.

FIG. 8 is a flowchart of an example method of detecting electromagnetic radiation, in accordance with techniques of the disclosure.

Like reference characters refer to like elements throughout the figures and description.

### DETAILED DESCRIPTION

Detecting infrared light, e.g., short-wave infrared (SWIR), mid-wave infrared (MWIR), and long-wave infrared (LWIR) is typically done with materials and/or techniques capable of detecting the lower energy light, e.g., indium gallium arsenide (InGaAs) or other sensors, and is typically outside of the wavelength range of silicon-based sensors. For example, the long wavelength cut-off of silicon-based sensors is typically about 1100 nanometers (nm), where the absorption of silicon cuts off. Due to the cost of the materials and processing, such infrared light sensors may cost many times more than silicon-based sensors. As used herein, ultraviolet (UV) light includes electromagnetic radiation having wavelengths from the tens of nm to the low range of the sensitivity of the human eye, e.g., from about 10 nm (deep UV) to about 380 nm. Visible light wavelengths range from about 380 nm to 700 nm, near infrared (NIR) wavelengths range from about 700 nm to 1100 nm, SWIR wavelengths range from about 1100 nm to 3000 nm (e.g., 1.1 um to 3 um), MWIR wavelengths range from about 3 um to 5 um, and LWIR ranges from about 5 um to 14 um.

Lower cost and/or simpler IR sensors may utilize an upconversion layer configured to convert SWIR light to visible and/or NIR light for detection using silicon as the detection material, albeit with a lower conversion efficiency, especially under low light conditions. For example, the conversion efficiency of a sensor utilizing an upconversion layer and silicon may be 1% or less for low light conditions.

This disclosure describes systems, sensors, and methods including an upconversion layer that increases a frequency of incident electromagnetic (EM) radiation (e.g., incident light) that is incident on the upconversion layer to a frequency range detectable by a photo-sensitive substrate, such as a silicon substrate, of the sensor and one or more light sources configured to emit light to the upconversion layer and that is configured to increase the upconversion efficiency of the upconversion layer. In some examples, the photo-sensitive substrate may comprise a material other than silicon, e.g., the photo-sensitive substrate may comprise a polymer, a piezoelectric material, quarts, lead zirconate titanate, or any other suitable material, e.g., having a long wavelength cutoff that is less than the EM radiation being detected and/or upconverted. In some examples, the systems and techniques described herein include upconverting processes that allows imagers and cameras to detect eye safe SWIR lasers directly for situational awareness or reflected signals off objects (e.g., in a scene external to the sensor, where the scene corresponds to, or is within, the field of view of the sensor), e.g., for distance ranging and/or for targeting.

In accordance with the systems, devices, and techniques described here, a sensor comprises and upconversion layer including a plurality of crystals configured to convert electromagnetic radiation having a first range of wavelengths greater than 1100 nm to electromagnetic radiation having a second range of wavelengths less than or equal to 1100 nm, a photo-sensitive silicon substrate, e.g., configured to detect the electromagnetic radiation having the second range of wavelengths, and a light source configured to emit electromagnetic radiation comprising the first range of wavelengths to the upconversion layer. The light source may also be referred to as an optical pump, in reference to “pumping” atoms of the crystals of the upconversion layer to a higher energy state, e.g., an intermediate energy state, to increase the conversion efficiency of light from the scene being detected, e.g., “signal light.”

In some examples, the crystals and upconversion layer may be applied to the front (e.g., top) or back (e.g., bottom) side of a silicon-based sensor and/or imaging sensor array, such as a CMOS imager, CCD imager, or the like. The application of the upconversion layer and crystals may not increase the dark current of the silicon-based sensor, may be applied “outside the foundry,” e.g., after fabrication of the silicon-based sensor or sensor array at a foundry and reduce and/or eliminate the need for specialized silicon foundry processing. For example, the upconversion layer and/or crystals may be applied to a silicon-based sensor and/or sensor array after silicon wafers are formed and/or delivered from a foundry, and application of the upconversion layer and/or crystals post-sensor fabrication may not increase the dark current of such silicon-based sensors. The upconverting layer may not increase size, weight or power of the imaging system including.

In some examples, the example sensors described here (e.g., sensors 101, 151 described below) may be useful for extending the responsivity of silicon-based sensors into the SWIR wavelength range, e.g., to sense SWIR sources such as laser designators and fiber optic systems or the like or to measure beam distribution for eye safe lasers (e.g., when used in a sensor array). In some examples, the example sensors described herein may enable a silicon-based array to image laser designator light and overlay the laser designator image on a color or grayscale image from a detector array. In other words, the example sensors described herein may extend the capabilities of silicon-based sensors to improve threat detection, identification of eye safe and non-eye safe laser designators, locating eye safe and non-eye safe laser designators in a scene (e.g., via overlay with an image of a scene showing the field of view of the sensor and/or sensor array), provide night vision while allowing a user to see/detect laser designators on a remote target as well as to locate a SWIR laser, e.g., if the user is being laser designated.

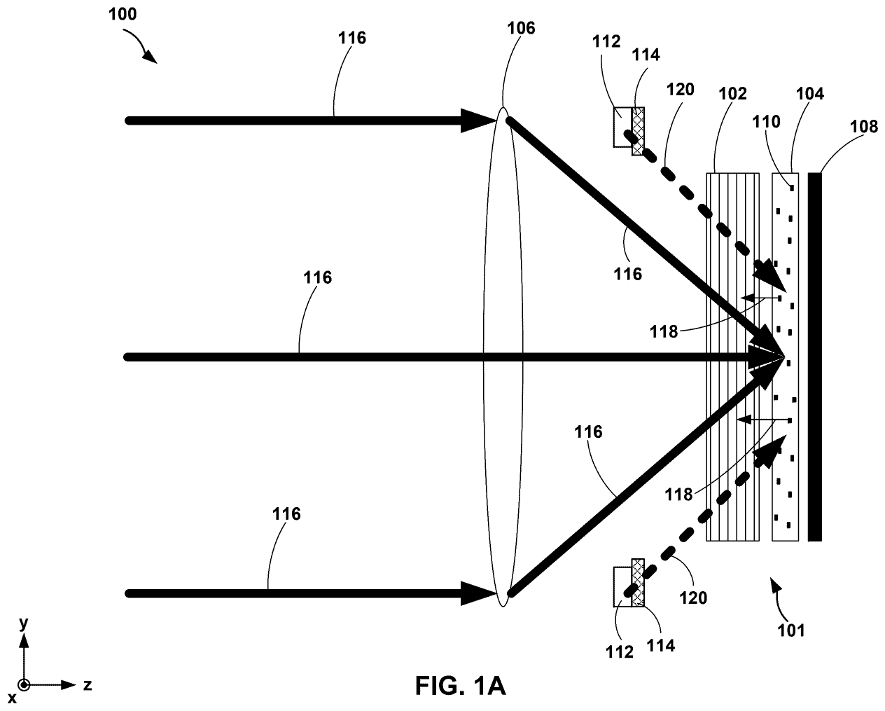

FIG. 1A is a cross-sectional block diagram illustrating a system 100 including an example sensor 101 in a first illuminated configuration, in accordance with techniques of the disclosure. In the example shown, system 100 includes lens 106, sensor 101, and reflector 108. System 100 may represent a LiDAR system, an image detection system, such as a camera, video camera, night-vision goggles, a scope, a monocular or binocular, mobile phone or tablet, some combination thereof, or portions thereof. In the example shown, sensor 101 includes upconversion layer 104, pump light source 112 configured to output pump light 120 to upconversion layer 104, and photo-sensitive silicon substrate 102 (also referred to herein as “silicon substrate 102”). Pump light 120 is electromagnetic radiation having a first range of wavelengths greater than 1100 nm. Sensor 101 may be configured to sense signal light 116, e.g., by upconverting signal light 116 and pump light 120 to detection light 118. Signal light 116 may be from a from a signal light source (i.e., not light source 112 of sensor 101) and/or object in a scene. Signal light 116 is electromagnetic radiation having a first range of wavelengths greater than 1100 nm. Signal light 116 may be, for example, shortwave infrared range (SWIR) electromagnetic radiation. Detection light 118 is electromagnetic radiation having a second range of wavelengths less than or equal to 1100 nm. In the example shown, the first illumination configuration comprises upconversion layer 204 disposed on the opposite side of silicon substrate 102 from incoming signal light 116, e.g., “in back of” silicon substrate 102. In this first illumination configuration, signal light 116, and in some examples pump light 120, pass through (e.g., transmit through) silicon substrate 102 before being incident on upconversion layer 104.

In some examples, a portion of detection light 118 may be from upconverted pump light 120 contributing to a constant bias signal level, or grayscale noise, detected by silicon substrate 102, and a portion of detection light 118 may be from upconverted signal light 116 detected by silicon substrate 102. In some examples, as described further below, the pump light 120, while increasing the overall noise detected by silicon substrate 102 (e.g., via upconversion of pump light 120 to detection light 118 and detection by silicon substrate 102), also improves conversion efficiency of signal light 116 such that the overall signal-to-noise (SNR) ratio of sensor 101 increases, particularly for low amounts, or low light levels, of signal light 116. In some examples, pump light 120 may help overcome scene shot noise.

Silicon substrate 102 may be configured to detect and/or sense detection light 118. For example, detection light 118 may comprise a range of wavelengths that is less than or equal to 1100 nm, e.g., UV/VIS/NIR light. In some examples, detection light 118 may comprise 980 nm light and/or 1020 nm light. In some examples, silicon substrate 102 may comprise a n-type channel within a p-type substrate (not shown in FIG. 1). Silicon substrate 102 may be substantially transparent to signal light 116 and pump light 120. For example, signal light 116 and pump light 120 may comprise a range of wavelengths that is greater than about 1100 nm, e.g., SWIR/MWIR/LWIR light, for which silicon substrate 102 may be substantially transparent. In some examples, signal light 116 and pump light 120 may comprise 1525 nm light, 1550 nm light, 2000 nm light, 2600 nm light, and/or 1530 to 1560 nm light. Although not illustrated in the figures, sensors that accord with techniques of this disclosure may include anodes, cathodes, support wires, a microlens, silicon doping, filters, and/or additional layers to support the operation of the sensor to convert detected electromagnetic radiation into electrical signals.

Upconversion layer 104 may include a plurality of crystals 110, and each crystal of the plurality of crystals 110 may be configured to convert at least a portion of signal light 116 and/or pump light 120 to a shorter range of wavelengths, e.g., to detection light 118. For example, crystals 110 may be configured to convert at least a portion of signal light 116 and/or pump light 120 comprising a first range of wavelengths greater than 1100 nm to detection light 118 comprising a second range of wavelengths less than or equal to 1100 nm. In some examples, the first range of wavelengths may comprise any wavelength greater than 1100 nm, and in some examples the first range of wavelengths may comprise one or more monochromatic or near-monochromatic wavelengths of light that are greater than 1100 nm, or one or more bands of wavelengths that are greater than 1100 nm, e.g., 1535 nm light, a band of 1535 nm to 1550 nm light, 1550 light, 2000 nm, 2600 nm light, or any combination thereof.

Crystals 110 may comprise a dopant configured to absorb signal light 116 and/or pump light 120 (e.g., electromagnetic radiation comprising the first range of wavelengths) and emit detection light 118 (e.g., electromagnetic radiation comprising the second range of wavelengths). Signal light 116 and pump light 120 may comprise one or more wavelengths that are the same, or may comprise the same wavelength(s) of light, e.g., signal light 116 and pump light 120 may both be electromagnetic radiation comprising the first range of wavelengths, with signal light 116 being the light from a scene that is intended to be detected, and pump light 120 being light that is added in order to improve the conversion efficiency of signal light 116 by crystals 110. In some examples, the dopant may comprise a rare-earth element, e.g., erbium, ytterbium, or any suitable rare-earth element. Crystals 110 may comprise a material and/or compound configured to retain the one or more dopants from dispersing, falling, aerating, or the like, and to allow signal light 116 and/or pump light 120 to reach the dopant for absorption. The material of crystals 110 may be further configured to allow the upconverted detection light 112 to exit crystals 110 so as to be absorbed/sensed/detected by silicon substrate 102. In some examples, crystals 110 may comprise a crystalline structure. In other examples, crystals 110 may comprise non-crystalline structure, and/or may not comprise crystalline structure. For example, crystals 110 may comprise a particle and/or material comprising a rare-earth element but not in crystalline form. In some examples, crystals 110 may comprise gadolinium oxysulfide and one or more dopants, e.g., Er +3 or ionized erbium with a positive 3 charge. In some examples, crystals 110 may comprise aluminum oxide (Al₂O₃) and one more dopants, e.g., Er +3.

In some examples, upconversion layer 104 and crystals 110 may be used with silicon substrate 102 in the first configuration as shown in FIG. 1A. FIG. 1B is a cross-sectional block diagram illustrating a system 150 including an example sensor 151 in a second configuration, in accordance with techniques of the disclosure. System 150 and sensor 151 may be substantially similar to system 100 and 101, except that system 150 and 151 illustrate an example second configuration in which upconversion layer 204 disposed on the same side of silicon substrate 102 as incoming signal light 116, e.g., “in front of” silicon substrate 102. In the second illumination configuration, signal light 116, and in some examples pump light 120, are incident on upconversion layer 104 before, or instead of, being incident on and/or transmitting through silicon substrate 102. For example, upconversion layer 104 and crystals 110 may be used with silicon substrate 102 in the second configuration (FIG. 1B) in which upconversion layer 104 and crystals 110 may overlie silicon substrate 102 by being disposed between silicon substrate 102 and signal light 116. In the first configuration (FIG. 1A), upconversion layer 104 and crystals 110 may underlie silicon substrate 102 by being disposed opposite silicon substrate 102 from signal light 116, e.g., the incident signal light 116 that reaches upconversion layer 104 and crystals 110 first transmits through silicon substrate 102, e.g., silicon substrate 102 may be substantially transparent to electromagnetic radiation comprising the first range of wavelengths greater than 1100 nm, such as signal light 116 and pump light 120. System 150 may represent a LiDAR system, an image detection system, such as a camera, video camera, night-vision goggles, a scope, a monocular or binocular, mobile phone or tablet, some combination thereof, or portions thereof.

In some examples, crystals 110 may range in size from greater than or equal to 0.1 micrometers (e.g., microns) and less than or equal to 100 micrometers. For example, crystals 110 may range in size from about 0.1 micrometers to about 100 micrometers, or from about 1 micrometer to about 20 micrometers, or from about 5 micrometers to about 10 micrometers. For example, crystals 110 may have an irregular shape, but each crystal may have an effective diameter of about 1 micrometer to about 20 micrometers, or from about 5 micrometers to about 10 micrometers. In some examples, the effective diameter of a crystal 110 may correspond to the largest dimension (e.g., longest length in a single direction) of the crystal 110. In some examples, the size of crystals 110 may be defined by the structure of the lattice and/or lattice size, which may in turn be defined by the material and/or materials comprising the crystals 110.

Crystals 110 comprise one or more dopants configured to convert signal light 116 and/or pump light 120 to detection light 116. For example, the one or more dopants may be configured such that atoms of the one or more dopants may be excited to a higher energy state by signal light 116 and/or pump light 120 and to have an emission spectra from the higher energy state comprising wavelengths less than or equal to 1100 nm. In the example shown, crystals 110 may comprise erbium-doped crystals configured to convert SWIR light (e.g., 1550 nm light) to NIR 980 nm light and/or 1020 nm light, and/or ytterbium-doped aluminum oxide crystals configured to convert SWIR light to visible and/or NIR light.

In some examples, upconversion layer 104 may be a layer that is separate from silicon substrate 102 and placed adjacent to and/or in contact with silicon substrate 102, and in other examples upconversion layer 104 may be disposed onto a surface of silicon substrate 102 and/or be attached to a surface of silicon substrate 102. In some examples, upconversion layer 104 further comprises a binder material. For example, upconversion layer 104 may comprise crystals 110 dispersed within a binder and/or encapsulating material. In some examples, the binder is configured to be compatible with crystals 110, e.g., so as to not quench upconversion by crystals 110. In other examples, upconversion layer 104 may not comprise a binder material and may represent a volume throughout which crystals 110 are dispersed. For example, crystals 110 may be placed on a surface of silicon substrate 102, e.g., “sprinkled,” airbrushed, or otherwise deposited over a surface area of silicon substrate 102, in the first or second illumination configuration. In other examples, crystals 110 may be disposed and/or dispersed onto and over a surface area of silicon substrate via a carrier material, e.g., crystals 110 may be coated onto silicon substrate 102. For example, crystals 110 may be dispersed within a relatively low viscosity material which may be subsequently removed after being disposed on silicon substrate 102, e.g., a low viscosity material such as a carrier liquid, a solvent, or other carrier material configured to disperse crystals 110 over a surface area of silicon substrate 110 when coated and/or sprayed onto silicon substrate 110. In the case of an alcohol as a carrier, the carrier may then subsequently evaporate, and upconversion layer 104 may comprise crystals 110 (including one or more dopants) dispersed over a surface area of silicon substrate 110. Although illustrated as separated from silicon substrate 102 in FIG. 1, upconversion layer 104 may be in contact with a surface of silicon substrate 102.

In some examples, crystals 110 may be held, attached, adhered, or otherwise affixed to a surface of silicon substrate 102. For example, upconversion layer 104 may comprise a binder configured to retain crystals 110 and adhere to silicon substrate 102. In other examples, crystals 110 may be held to silicon substrate 102 an electrical charge, e.g., via an electrical and/or electrostatic charge (e.g., and without a binder material and/or carrier material).

In the example shown in FIG. 1A, sensor 101 in the first illumination configuration includes reflector 108. Reflector 108 may be configured to reflect and/or redirect detection light 118, e.g., back towards silicon substrate 104. In the example shown, upconversion layer 104 and reflector 108 both underlie silicon substrate 102, with upconversion layer 104 being disposed between reflector 108 and silicon substrate 102. For example, upconversion layer may be adjacent to, underlie, and/or may be in contact with a dielectric layer that is adjacent to, underlies, and/or is in contact with a surface of silicon substrate 402, and reflector 108 underlies upconversion layer 104.

Reflector 108 may comprise a metal and/or a dielectric material. For example, reflector 108 may comprise silver, gold, aluminum, or any suitable metal configured to reflect detection light 118, e.g., light having wavelengths less than or equal to 1100 nm. In other examples, reflector 108 may comprise one or more dielectric materials, e.g., a dielectric mirror or Bragg mirror, or a coating comprising dielectric materials and/or layers configured to reflect detection light 118.

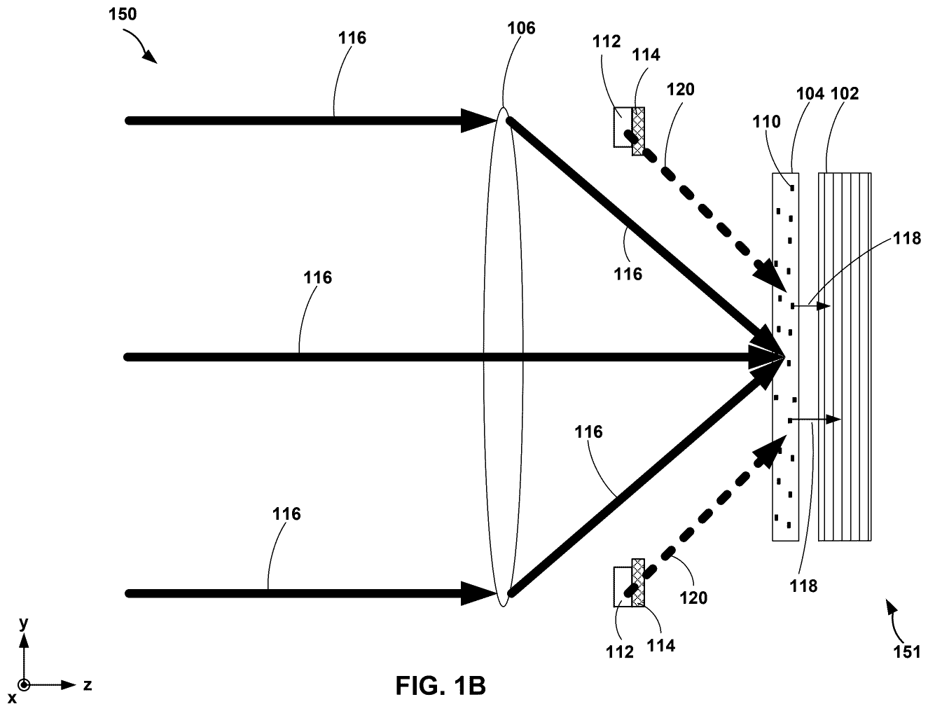

FIG. 2A is a cross-sectional block diagram illustrating the example sensor of FIG. 1A, in accordance with techniques of the disclosure. FIG. 2A is an enlarged view of sensor 101 illustrating silicon substrate 102, upconversion layer 104, reflector 108, and light source 112. In some examples, such as the first illumination configuration of FIGS. 1A and 2A, upconversion layer may be substantially transparent to detection light 118. For example, crystals 110 may be spaced such that upconversion layer 104 is substantially transmissive to detection light 118, and/or upconversion layer 104 and crystals 110 are substantially transmissive to detection light 118, e.g., regardless of the spacing, density, and/or concentration of crystals 110.

In some examples, with reference to FIG. 2A, crystals 110 may emit detection light 118 in any direction, a portion of which is emitted towards silicon substate 102 and a portion of which is emitted towards reflector 108. Reflector 108 may reflect detection light 118 back through upconversion layer 104, which may be at least partially, or substantially, transparent to detection light 118.

Light source 112 may comprise any suitable light source configured to emit pump light 120, e.g., light comprising wavelengths greater than 1100 nm. For example, light source 112 may comprise a light emitting diode (LED), an IR laser, an incandescent light source, a luminescent light source, an arc lamp, or the like. Light source 112 may be configured to emit pump light 120 comprising one or more wavelengths suitable for pumping atoms or molecules of crystals 110 to the metastable intermediate state |a>, e.g., pump light 120 may comprise wavelengths such that photons of pump light 120 have an energy or energies substantially matching the energy transition between ground state |GS> and metastable intermediate state |a> (FIG. 2B). In some examples, light source 112 may be configured to emit pump light 120 having a very narrow wavelength band, e.g., substantially monochromatic pump light 120, so as to reduce excess shot noise. Light source 112 may be arranged to irradiate at least a portion of the surface area of upconversion layer 104. For example, light source 112 may be positioned and/or aimed to emit light towards upconversion layer 104. Light source 112 may include optics, e.g., mirrors, lenses, diffraction gratings, or the like, configured to redirect, converge, and/or diverge emitted pump light 120 towards upconversion layer 104. Light source 112 may be positioned within the field of view of sensor 101 but not part of the scene, e.g., the scene being detected and/or imaged by sensor 101. In some examples, light source 112 may be positioned outside of the field of view of sensor 101 (and not in the scene being detected and/or imaged by sensor 101) but still configured to emit pump light 120 to upconversion layer 104.

In some examples, light source 112 may comprise a plurality of light sources 112 arranged circumferentially about an axis perpendicular to a surface of upconversion layer 104, which may be an optical axis 130 of sensor 101 (FIG. 2A), such that light sources 112 shine pump light 120 from an off-axis angle to evenly irradiate at least a portion of the surface area and/or volume of upconversion layer 104, e.g., with a substantially constant irradiance of pump light 120 over a surface area of the upconversion layer 104. For example, light source 112 may be arranged off-axis so as to maintain a clear aperture defined by sensor 101, e.g., for signal light 116 to enter sensor 101. That is, sensor 101 may define a clear aperture configured to signal light 116, emitted and/or reflected by an object in a scene external to sensor 101, to be incident on upconversion layer 104, and light source 112 is configured to not obstruct the clear aperture. In some examples, light source 112 may comprise a ring light, or one or more emitters and optical components (e.g., light pipes or waveguides) configured emit pump light 120 from a ring that is circumferential about axis 130 to substantially evenly irradiate at least a portion of the surface area and/or volume of upconversion layer 104.

In some examples, light source 112 is configured to emit electromagnetic radiation pump light 120 to the upconversion layer 104 through silicon substrate 102, e.g., such as in the first illumination configuration of FIGS. 1A and 2A. For example, silicon substrate 102 may be partially or substantially transparent to pump light 120, e.g., silicon substrate 102 may be configured to substantially transmit signal light 116 and/or pump light 120. In some examples, light source 112 may be configured to emit pump light 120 to upconversion layer 104 such that the pump light 120 emitted by the light source does not exit sensor 101 without being upconverted. For example, light source 112 may be at such an angle with respect to axis 130, and sensor 101 may include optical components, baffles, apertures, or the like, configured to block and/or redirect light, such that light source 112 emits pump light 120 to upconversion layer 104 and any unconverted pump light 120 is absorbed, blocked, redirected to upconversion layer 104 again (e.g., for a second pass and chance to be absorbed by crystals 110) and/or trapped such that substantially all of pump light 120 stays within sensor 101 and does not exit sensor 101. Although shown as “behind” lens 106 in FIGS. 1A and 2A, light source 112 and filter 114 may be otherwise positioned, e.g., in front of lens 106, behind or on the opposite side of silicon substrate 102, or at any position so long as light source 112 may emit pump light 120 to irradiate upconversion layer 104.

In some examples, light source 112 (or light sources 112) includes wavelength filter 114. Wavelength filter 114 may be configured to pass (e.g., transmit) a portion of pump light 120, e.g., light (electromagnetic radiation) comprising a first range of wavelengths, and reduce or block other wavelengths of light (electromagnetic radiation), e.g., reduce or block light (electromagnetic radiation) not comprising the first range of wavelengths. In some examples, wavelength filter 114 may be a cut filter configured to block 1100 nm or less light and pass or transmit light greater than 1100 nm, a bandpass filter, a narrow-band filter, or the like. In some examples, wavelength filter 114 may comprise a bandpass filter configured to pass wavelengths corresponding in energy sufficient to excite atoms and/or molecules of crystals 110 to the metastable intermediate energy state |a> (FIG. 2B). For example, wavelength filter 114 may be configured, in conjunction with crystals 110, to select particular wavelengths of pump light 120 suitable to increase the conversion efficiency of particular wavelengths of light, e.g., 1535 nm, 1550 nm, 2000 nm, 2600 nm, with substantially narrow spectral bands corresponding to the appropriate and/or allowed energy states for a two-photon transition of the atoms of crystals 110. In some examples, wavelength filter 114 may be configured to transmit only the wavelengths of pump light 120 suitable for increasing the energy state of the atoms of crystals 110 to improve the conversion efficiency of signal light 116 and to reduce and/or block other wavelengths of pump light 120, e.g., to reduce stray light that may otherwise be converted by other atomic transitions of upconversion layer 104 and contribute to noise and/or that may otherwise exit sensor 101.

In some examples, pump light 120 emitted by light source 112 to upconversion layer 104 may be a first EM radiation comprising a first range of wavelengths greater than 1100 nm, and signal light 116 may be a second EM radiation comprising the first range of wavelengths greater than 1100 nm. For example, sensor 101 may include light source 112 configured to emit first EM radiation, e.g., pump light 120, to upconversion layer 104 and upconversion layer 104 may be configured to receive and convert second EM radiation, e.g., signal light 116 that is not pump light 120, to EM radiation comprising the second range of wavelengths less than or equal to 1100 nm, e.g., detection light 118.

FIG. 2B is an illustration of an example energy diagram 200 of an atom of a crystal 110 of upconversion layer 104, in accordance with techniques of the disclosure. In some examples, energy diagram 200 illustrates an energy diagram of an atom of a dopant, e.g., a rare earth atom of crystal 110. In some examples, energy diagram 200 illustrates an energy diagram of an atom and/or molecule of crystal 110.

In the example shown, signal light 116 may be 1550 nm wavelength light, which may drive a transition of an atom or molecule of crystals 110 from the ground state |GS> to a higher energy state |a>, which may be a metastable intermediate state, e.g., a photon of 1550 nm signal light 116 may drive the atom or molecule of crystals 110 to a metastable intermediate state. In order to drive a transition of the atom or molecule of crystals 110 to the higher energy state |b> from which the atom or molecule may decay back to the ground state |GS> by emitting a photon of detection light 118 (e.g., either spontaneously or via stimulated emission), the atom or molecule may absorb a second photon of signal light 118. For example, there may be one or more metastable intermediate energy states allowed for the atoms or molecules of crystals 110 such that multiple photons of signal light 116 may excite the atoms or molecules to a higher energy state from which a photon having more energy, and a higher frequency and shorter wavelength, than the photon of signal light 116 may be emitted, thereby upconverting signal light 116 to detection light 118.

In some examples, for low amounts of signal light 116 (e.g., low signal light 116 conditions), signal light 116 may excite only a low number, amount, and/or density of crystals 110 to the metastable intermediate energy state |a>, and the low amount of signal light 116 may have a low probability of further exciting crystals 110 to the higher energy state |b>, thereby resulting in a decreased and/or low conversion efficiency of crystals 110. Additionally, or alternatively, in some examples, for low amounts of signal light 116 the atom or molecule of crystals 110 excited to the metastable intermediate energy state |a> may decay before a second photon of signal light 116 arrives, thereby decreasing the conversion efficiency of crystals 110. The atom or molecule may decay to the ground state |GS> or an allowed lower energy state (not shown) via emission (spontaneous or stimulated) of a photon or a phonon (e.g., as vibrational energy to other atoms and/or molecules in a crystal lattice of crystals 110. In some examples, the atom or molecule may decay via transfer energy to another atom or molecule via a collision with another atom or molecule, however, only to the extent the atom or molecules are mobile within crystals 110. In some examples, without light source 112 and pump light 120, the conversion efficiency and/or a probability of conversion of a photon of signal light 116 may be proportional to the amount of signal light 116, e.g., at least for amounts of signal light 116 up to a threshold amount at which for larger amounts of signal light 116 the conversion efficiency and/or probability of conversion is substantially constant, e.g., the metastable intermediate state |a> is substantially highly populated.

A LiDAR system emitting signal light 116, the distance range limit may be determined by the amount of return signal light 116 after reflecting and/or scattering back from an object in a scene external to sensor 101, e.g., the distance range may be limited by the brightness of the return signal light 116. The limit of the distance range may correspond to a threshold amount of detection light 118 received by silicon substrate 102 that may have a signal-to-noise (SNR) ratio above a threshold SNR amount and/or value. Increasing the conversion efficiency, or quantum efficiency, of crystals 110 may increase the SNR of detection light 118, and increase the distance range of a LiDAR system using sensor 101, e.g., sensor 101 may convert and detect lower levels of signal light 116, e.g., such as signal light 116 returning from more distance objects.

In some examples, sensor 101 may increase the conversion efficiency of crystals 110 via excited state absorption (ESA). For example, sensor 101 may increase the conversion efficiency of crystals 110 by increasing the population of atoms or molecules excited to the metastable intermediate energy state |a>. In this way, when a photon of signal light 116 is absorbed by an atom or molecule of crystals 110, the photon may excite the atom or molecule from the metastable intermediate state |a> to the higher energy state |b> from which a detection light 118 photon may be emitted, rather than being absorbed to excite the atom or molecule from the ground state |GS> to the metastable intermediate state |a> after which the atom or molecule may decay back to the |GS> without being excited to the higher energy state |b>, in which case the signal light 116 may be lost without registering or being counted/detected by silicon substrate 102. For example, light source 112 may emit pump light 120 to upconversion layer 104 thereby exciting atoms or molecules of crystals 110 to the metastable intermediate energy state |a>, e.g., to pump the crystals 110 to the |a> energy state and populate the metastable intermediate energy state |a> (e.g., populate upconversion layer 104 with a plurality of crystals 110 each including a plurality of atoms or molecules excited, or pumped, to the metastable intermediate energy state |a>). Light source 112 may be configured to emit a constant amount (e.g., over time) of pump light 120 to irradiate an area or volume of upconversion layer 104 substantially evenly to increase the population of atoms or molecules of crystals 110 to a threshold level substantially evenly over time and area (and/or volume) of upconversion layer 104. In some examples, with light source 112 and pump light 120, the conversion efficiency and/or a probability of conversion of a photon of signal light 116 may be substantially independent of, rather than proportional to, the amount of signal light 116, e.g., for amounts of signal light 116 lower than the threshold amount described above at which the signal light 116 populates the metastable intermediate state |a> without the aid of pump light 120.

In some examples, light source 112 may be configured emit an amount of pump light within a range, e.g., greater than a threshold minimum amount of pump light 120 so as to increase the conversion efficiency of crystals 110 and less than a threshold maximum of pump light 120 at which point an increase in the conversion efficiency of crystals 110 by increasing the population of atoms or molecules to the metastable intermediate energy state |a> drops off, reduces, or ceases, e.g., at which point additional amounts of pump light 120 contributes to noise, e.g., which may be excess shot noise, at a higher rate relative to increasing the conversion efficiency. For example, pump light 120 received by crystals 110 from light source 112 may cause atoms or molecules to excite from the metastable intermediate energy state |a> to the higher energy state |b> as well as from the |GS> to the metastable intermediate energy state |a>, e.g., two-photon of pump light 120 may excite the atoms or molecules to the higher energy state |b> without absorbing a photon of signal light 116. The atoms or molecules may them emit a detection light 118 photon to silicon substrate 102, which may detect the detection light 118 photon which is a photon contribution to “background” noise rather than from signal. In other words, too little pump light 120 from light source 120 may result in a decreased distance range of a LiDAR system due to low conversion efficiency, and too much pump light 120 from light source 120 may result in a larger contribution to noise reducing the SNR of sensor 101, thereby reducing the distance range of the LiDAR system. In some examples, noise generated by pump light 120 upconversion may not be a significant sensing limiter, e.g., for brighter background scenes. For example, increasing the amount of pump light 120 may not significantly increase total noise, which may be dominated by noise from a bright background scene, but the increased amount of pump light 120 may cause an increased upconversion efficiency for signal light 116 and an increased amount of detection light 118 due to upconversion of signal light 116, and making it possible to sense/detect the laser signal amidst the relatively higher background illumination.

For example, for a nighttime scene with a quarter or half-moon illumination, system 100 (or system 400 described below) may be configured to set the amount of pump light 120 using a sample of the background illumination level, e.g., from an irradiance and/or illuminance sensor (not shown). If the background illumination is very low, the amount of pump light 120 may be reduced to improve and/or optimize the signal-to-noise ratio (SNR). If the scene background illumination is relatively higher, the amount of pump light 120 may be increased to overcome scene shot noise.

In some examples, sensor 101 and/or 151 may be configured to additionally sense electromagnetic radiation comprising the second range of wavelengths less than or equal to 1100 nm (e.g., visible and/or NIR light) from a scene. For example, sensor 101 and/or 151 may be configured to sense, detect and/or image the visible and NIR light from a scene in addition to sensing, detecting, and/or imaging signal light 116, e.g., via upconversion of signal light 116 to detection light 118. In some examples, sensor 101 and/or 151 may be configured to image color image of the scene in addition to sensing, detecting, and/or imaging signal light 116 as described above. For example, sensor 101 may be configured to image visible and/or NIR light onto silicon substrate 102, and sensor 151 may be configured to image visible and/or NIR light into silicon substrate 102 through upconversion layer 104, e.g., upconversion layer 104 may be at least partially transmissive to visible and/or NIR light.

In some examples, light source 112, or light source 112 and wavelength filter 114, are configured to emit substantially narrowband pump light 120 to upconversion layer 104, e.g., so as to excite the atoms or molecules of crystals 110 to the correct energy levels for increasing conversion efficiency for the wavelengths of signal light 116 of interest and not exciting the atoms or molecules to other energy levels that may contribute to noise, e.g., detection light 118 emitted from other energy levels not involved in absorbing and upconverting signal light 116. For example, light source 112 may be a 1550 nm laser, or light source 112 may be a 1550 nm LED and wavelength filter 114 may be a bandpass filter centered about 1550 nm and having a band pass wavelength range of about 100 nm or less, or 50 nm or less, or 10 nm or less, or 5 nm or less, or any suitable wavelength band. In some examples, light source 112 may be configured to output substantially monochromatic pump light 120 (e.g., a laser), or light source 112 and wavelength filter 114 are configured to output substantially monochromatic pump light 120. In some examples, the peak output wavelength of light source 112 and wavelength filter 114 may correspond to the wavelength or wavelengths of signal light 116 to be converted, e.g., the peak output wavelength of light source 112 and wavelength filter 114 may be 1550 nm to emit pump light 120 comprising 1550 nm to upconvert 1550 nm signal light 116. In some examples, system 100 including sensor 101 may include a light source (not shown) configured to emit the light of signal light 116, e.g., such as for a LiDAR system 100. The light source may comprise a rare-earth doped glass pulsed laser, e.g., an erbium doped glass pulsed laser configured to emit 1535 nm light, or 1550 nm light. In some examples, the light source may be configured to emit 2000 nm wavelength light, 2600 wavelength light, or any wavelength light suitable for upconversion via upconversion layer 104. The emitted signal light 116 may interact with an environment external to sensor 101 and/or system 100, such as reflecting or scattering from an object, and return to system 100 and to sensor 101 as signal light 116. Light source 112 may be configured to emit pump light 120 including the same wavelength as signal light 116 and filter 114 may be configured to reduce and/or block other wavelengths of pump light 120, e.g., wavelengths not useful for increase the conversion efficiency of sensor 101. For example, light source 112 may be a 1535 nm LED light source and wavelength filter 114 may be a 1500 nm to 1550 nm bandpass filter.

In other examples, the peak output wavelength of light source 112 and wavelength filter 114 need not be centered on the wavelength or wavelengths of signal light 116, but rather may include the wavelength or wavelengths of signal light 116. For example, light source 112 may be a 1535 nm LED having a relatively broad spectral output and wavelength filter 114 may be a bandpass filter centered on 1535 nm or 1550 nm and have a spectral transmission bandwidth sufficient to allow light source 112 and wavelength filter 114 to emit pump light 120 comprising 1550 nm to upconvert 1550 nm signal light 116.

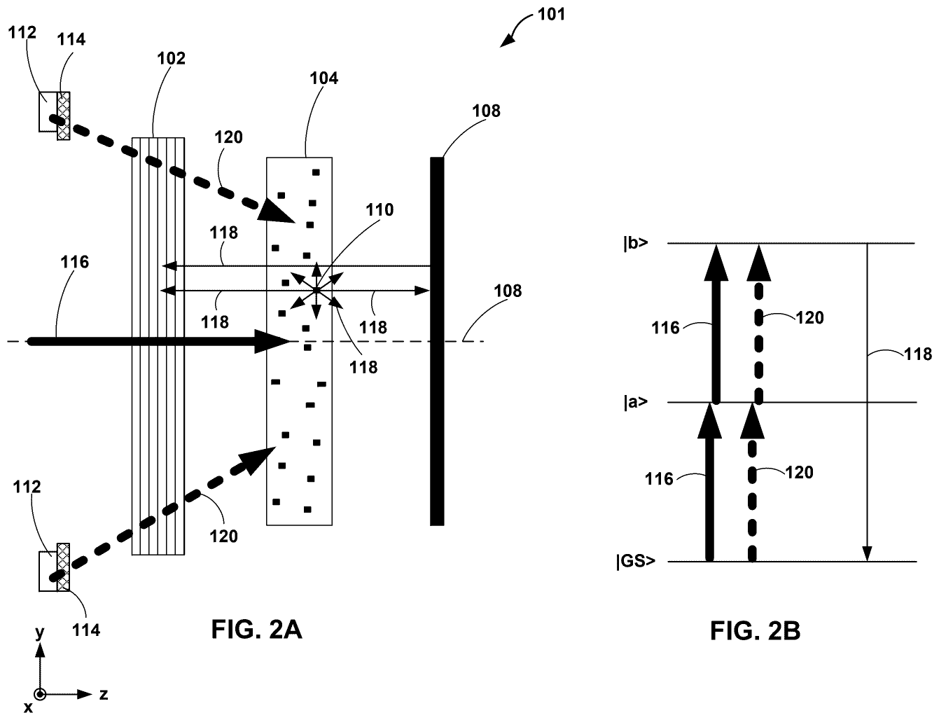

FIG. 3 is an example plot 300 illustrating the mean signal per pixel received by sensor 101, e.g., silicon substrate 102, as a function of the amount of signal light 160, in accordance with techniques of the present disclosure. For example, silicon substrate 102 may comprise an array of photo-sensitive pixels. In the example shown, the mean signal per pixel may be output by sensor 101 after sensing or detection of detection light 118 by silicon substrate 102 and digitization to digital numbers (DN), where detection light 118 is indicative of the amount of signal light 116 received by sensor 101 from a scene. Also in the example shown, the maximum signal of sensor 101, or the saturation signal, is 40000 DN, and the scale in plot 300 is up to 30 DN, indicating that plot 300 illustrates mean signal per pixel received by sensor 101 as a function of the amount of signal light 160 for low levels or amounts of signal light 160.

In the example shown, plot 300 includes curves 302, 304, and 306, each of which is a curve corresponding to the mean signal received by sensor 101 as a function of the amount of signal light 116 for a different amount of pump light 120 from light source 112 of sensor 101. For example, an external signal light source (e.g., external to sensor 101) and target object within the field of view of sensor 101 may be used to control the amount of signal light 116 to generate plot 300. In the example shown, for conversion of photons of signal light 116 to detection light 118 that is independent of the amount of signal light 116, each of curves 302-304 would be linear plots having a slope corresponding to the upconversion efficiency, whereas curvature of curves 302-304 indicate that there is a dependence on the conversion efficiency upon the amount of signal light. In the example shown, the instantaneous slope of each of curves 302-304 is indicative of the upconversion efficiency of upconversion layer at that level and/or amount of signal light 116. The increase in mean signal per pixel between the curves 302-304 is indicative of receiving signal due to conversion of signal light 116 and pump light 120, and the relative slopes of each of curves 302-304 as compared to each other are indicative of the change of upconversion efficiency of signal light 116 as a function of amount of pump light 120.

In the example shown, the amount of pump light 120 is indicated for each of curves 302-304 as a pump light induced emission, or pump light noise bias or read noise, in units of electrons (e−) per pixel, e.g., the number of electrons per unit of time that is read by readout electronics connected to silicon substrate 102, which may be a component of the overall read noise of sensor 101. For example, sensor 101 may readout 0.0 e−per pixel pump light read noise for no pump light 120 for curve 302 (e.g., light source 112 being off or not emitting pump light 120), sensor 101 may readout 0.88 e−per pixel pump light read noise for a first level or amount of pump light 120 from light source 112 for curve 304, and sensor 101 may readout 3.16 e−per pixel pump light read noise for a second, higher level or amount of pump light 120 from light source 112 for curve 306. The pump light read noise increases with increasing the level or amount of pump 120 and may manifest as a grayscale background noise level from sensor 101.

In the example shown, at a signal light 116 level corresponding to the 50 microwatt output on the x-axis, the converted detection light 118 gain for curve 304 for the pump light 120 level corresponding to the 0.88 e−bias relative to curve 302 for the zero pump light 120 is a factor of 6.5, and the total root-mean-squared (rms) read noise for curve 304 is 1.4 e−. The converted detection light 118 gain for curve 306 for the pump light 120 level corresponding to the 3.16 e−bias relative to curve 302 for the zero pump light 120 is a factor of 10.4, and the total root-mean-squared (rms) read noise for curve 306 is 2.01 e−. As shown in FIG. 3, the gain factor increase for the increasing pump light 120 levels due to increased conversion efficiency with pump light 120 (e.g., indicated by increasing slope with increasing pump light 120) are greater than the pump light induced read noise at low levels of signal light 116, thereby improving the SNR of sensor 101 and the distance detection range of sensor 101. For example, the array of photo-sensitive pixels may have a read noise of about 1 e−. Noise from pump light 120 may be the square root of the amount of pump light. For a bias=3.16 e−, shot noise may be 1.77 e−rms. The total noise may be the sum of the read and shot noises in quadrature, e.g., about 2 e−rms. For a low signal light level, such as the 50 microwatt signal light output power shown in plot 300, the mean signal per pixel for curve 306 (with pump light 120 on and at an amount corresponding to a 3.16 e−bias) increases by about a factor of 10 relative to curve 302 (no pump light 120), while the total noise increases by about a factor of 2, resulting in a SNR increase of about a factor of 5 in the example shown.

In some examples, without pump light 120 (e.g., curve 302), the mean signal per pixel response for low signal light 116 levels is non-linear, e.g., follows the square of the signal light level 116, for a two-photon conversion process of upconversion layer 104.”, and the addition of pump light 120 from light source 112 causes the two-photon transition of upconversion layer 104, and of sensor 101, to be more linear, e.g., due to increasing the population of atoms or molecules of crystals 110 that are excited to the metastable intermediate energy state |a> and thereby reducing the randomness of upconverting a 1550 nm photon to the desired |b> energy level (e.g., random because of a low population of atoms or molecules of crystals 110 being excited to the metastable intermediate energy state |a>). In some examples, the added linearity results in higher sensitivity of sensor 101 at low signal 116 light levels, and the relative gain factor for lower signal light 116 levels gain increase is greater, e.g., the gain factor for curves 304 and 306 relative to curve 302 is greater at the lower signal light 116 levels as shown.

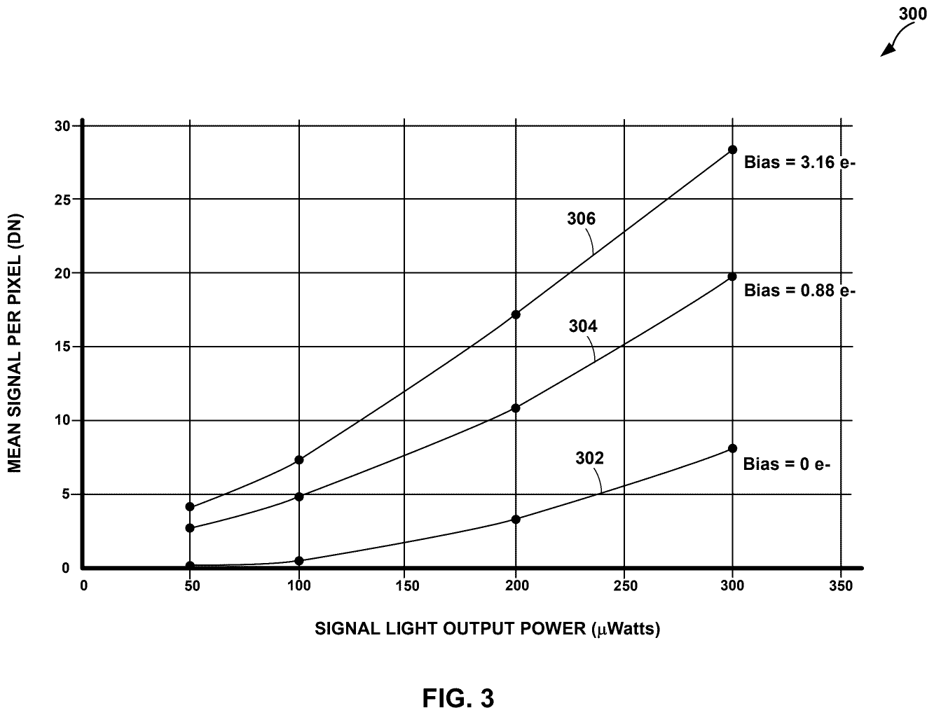

FIG. 4 is a cross-sectional diagram and block diagram illustrating an example system 400, in accordance with techniques of the disclosure. In the example shown, system 400 includes system 100 for detecting signal light 116 and computing device 420 communicatively coupled to system 100 for processing data related to detected signal light 116. In the example shown, system 100 may be substantially similar to system 100 of FIG. 1, and may be a LiDAR camera. While shown and described with respect to system 100, other examples of system 400 may include system 150.

FIG. 4 also illustrates computing device 420 that includes processing circuitry 416 and memory 424 communicatively coupled to processing circuitry 416.

Computing device 420 may be configured to receive signals from sensor 101 indicative of detection light 118 and signal light 116. Computing device 420 includes computation engine 422, memory 424, communication unit 418, processing circuitry 416, one or more hardware user interfaces 428 (hereinafter “hardware user interface 428”), one or more output devices 426, and light source controller 430. In the example of FIG. 4, a user of computing device 420 may provide input to computing device 420 via one or more input devices (not shown) such as a keyboard, a mouse, a microphone, a touch screen, a touch pad, or another input device that is coupled to computing device 420 via one or more hardware user interfaces 428.

Output devices 426 may include a display, sound card, video graphics adapter card, speaker, presence-sensitive screen, one or more USB interfaces, video and/or audio output interfaces, or any other type of device capable of generating tactile, audio, video, or other output. Output devices 426 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e−ink, or monochrome, color, or any other type of display capable of generating tactile, audio, and/or visual output.

Computing device 420, in some examples, includes communication unit 418 and light source controller 430. Communication unit 418 is configured to receive input electrical signals and/or send output electrical signals from and/or to one or more sensors, such as sensor 101 and/or silicon substrate 102, and light source controller 430 is configured to receive input electrical signals and/or send output electrical signals from and/or to one or more light sources 112. Communication unit 418 and light source controller 430 may transmit to and/or receive electrical signal output/input sensor 101, silicon substrate 102, and/or light source 112 (respectively) via wired or wireless connections. For example, computing device 420 may communicate via light source controller 430 and communication unit 418 to configure light source 112 and/or sensor 101 and/or silicon substrate 102. Communication unit 418 and light source controller 430 may be configured to convert the received electrical signals into a form usable by computing device 420. For example, communication unit 418 and light source controller 430 may include software or hardware configured to convert a received signal input from an analog signal to a digital signal, e.g., circuitry configured to convert signals from/to silicon substrate 102 and/or light source 112 to digital and/or analog signals to send/receive from computation engine 422. In another example, communication unit 418 and light source controller 430 may include software or hardware configured to compress, decompress, transcode, encrypt, or decrypt a received signal input into a form usable by computing device 420. In another example, communication unit 418 and light source controller 430 may include a network interface device to receive packetized data representative of image data, sensed or detected signal light 116 and/or detection light 118, and/or input/output data. In such examples, an intermediate device may packetize signals to produce the packetized data and send the packetized data to computing device 420. In this manner, communication unit 418 and light source controller 430 may be configured to interface with, or communicate with sensor 101 and/or silicon substrate 102 and/or light source 112. For example,

Computation engine 422 may be implemented in circuitry. For instance, computation engine 422 may include processing circuitry 416, which may be any one or more of a microprocessor, a controller, a digital signal processor (DSP), an application specific integrated circuit (ASIC), a field-programmable gate array (FPGA), or equivalent discrete or integrated logic circuitry. The functions attributed to processors described herein, including computation engine 422 and processing circuitry 416, may be provided by processing circuitry of a hardware device, e.g., as supported by software and/or firmware. Computation engine 422 may be configured to generate a digital image and/or ranging information based on signals received from sensor 101 and/or silicon substrate 102. Computation engine 422 may also be configured to control the output of light source 112 and receive information indicative of the output of light sources 112, e.g., feedback regarding brightness and spectral content of light source 112.

Processing circuitry 416 may be communicatively coupled to system 100, for example via communication unit 418 and/or light source controller 430. For example, processing circuitry 416 may process signals received via communication unit 418 from sensor 101 and/or silicon substrate 102 indicative of signal light 116 and detection light 118, and/or received via light source controller 430 from light source 112 indicative of pump light 120. In some examples, processing circuitry 416 may control the output of light source 112 and receive information indicative of the output of light source 112, e.g., feedback regarding brightness and spectral content of light source 112.

In some examples, computation engine 422 may include memory 424. Memory 424 may include any volatile or non-volatile media, such as a random-access memory (RAM), read only memory (ROM), non-volatile RAM (NVRAM), electrically erasable programmable ROM (EEPROM), flash memory, and the like. Memory 424 may be a storage device or other non-transitory medium. Memory 424 may be used by processing circuitry 416 to, for example, store information related to system 100, such as images, image information, distance ranging information, sensor 101 settings, light source 112 settings, and any other suitable settings for system 100. In some examples, processing circuitry 416 may store image information, distance ranging information, or previously received data from electrical signals in memory 424 for later retrieval. In some examples, processing circuitry 416 may store determined values or any other calculated values, in memory 424 for later retrieval. In some examples, computing device 420 may be integrated with system 100. In other examples, computing device 420 may be an external device, e.g., a computing device separate from system 100 and configured to communicate with system 100.

In some examples, computing device 420 (e.g., any or all of processing circuitry 416, communication unit 416, and light source controller 430) may be configured to determine a pump light 120 and cause light source 112 to emit the determined amount of pump light 120. For example, computing device 420 may determine a pump light 120 amount based on upconverted pump light 120 signal (e.g., the portion of detection light 118 from pump light 120) and/or an amount of background light in the scene. In some examples, computing device 420 may be configured to determine a pump light 120 amount resulting in an improved, increased, and/or optimal or maximum SNR for detection of signal light 116, e.g., based on any or all of scene content, background light levels in the scene, and/or the amount of signal light 116. In some examples, computing device 420 may automatically control light source 112 to adjust the amount of pump light 120 based on signal light 116 level and/or an amount of background scene light, e.g., to improve the SNR of sensor 101 and/or a distance range of system 100 such as for low signal light 116 levels that are background shot noise limited. In some examples, it may be more beneficial to increase the upconversion efficiency of signal light 116 rather than minimize noise due to pump light 120 because the background scene shot noise is the larger contributor to noise. By way of contrast, for a very dark or low brightness level background scene the sensor 101 read noise may be the larger contributor to the overall sensor 101 noise, and it may be more beneficial to reduce the amount of pump light 120 so as to not degrade the noise floor.

For example, for higher background scene light amounts, computing device 420 may increase the amount of pump light 120 because sensor 101 read noise may no longer be the detection limiter. Instead, the detection limiter may be scene shot noise. Computing device 420 may cause light source 112 to output an increased amount of pump light 120 to upconversion layer 104 if the upconverted pump light 120 photon shot noise does not significantly exceed scene shot noise, and the increased pump light 120 may increase the upconversion efficiency of signal light 116 and increase the upconverted signal light 116 such that the signal light 116 may be sensed and/or detected with the relatively brighter background light. In some examples, system 400 may provide upconverted signal light 116 for night vision over a wider dynamic range of background illumination and/or brightness levels, e.g., from overcast starlight to full moon. At full moon, computing device 420 may cause light source 112 to increase the amount of pump light 120 so weaker signal light 116 may be upconverted to detection light 118 with a higher efficiency so as to be sensed/detected against the relatively brighter moonlit background, and for overcast starlight, computing device 420 may cause light source 112 to reduce the amount of pump light 120 so as to reduce read noise caused by pump light 120.

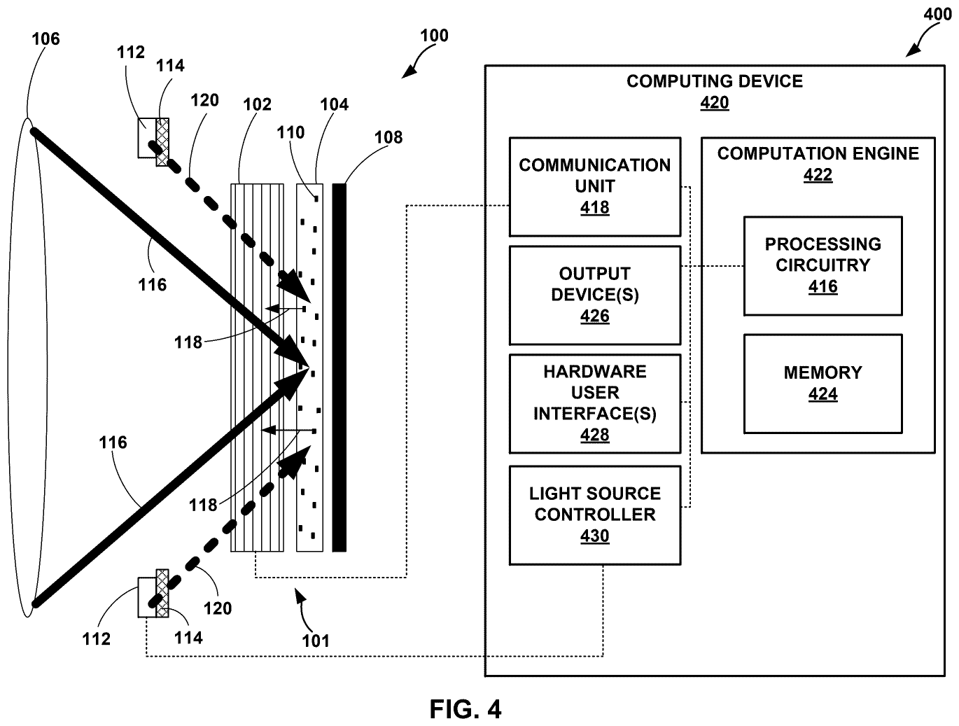

In some examples, the amount of upconversion efficiency increase and/or gain may increase more slowly, or not increase for amounts of pump light 120 greater than a threshold level, or the upconversion efficiency increase and/or gain may asymptote off for higher amounts of pump light 120. FIG. 5 is an example plot 500 illustrating detection light 118 increase as a function of light source 112 driving current, e.g., which is proportional to pump light 120, for a particular amount of signal light 116, in accordance with techniques of the present disclosure. In the example shown, a plot 300 corresponds to 4 adjacent pixels (arranged in a 2×2 grid) of silicon substrate 102 at the location of a SWIR laser spot in a scene, e.g., signal light 116. The signal light 116 of the SWIR spot is held to a constant amount, e.g., corresponding to a 400 microwatt output of the SWIR laser. In the example shown, as the light source 112 driving current, and amount of pump light 120, increases, the increase in detection light 118 (shown in units of electrons e−read out from the 2×2 pixels) asymptotes off to a substantially constant level for increased pump light 120 amounts.

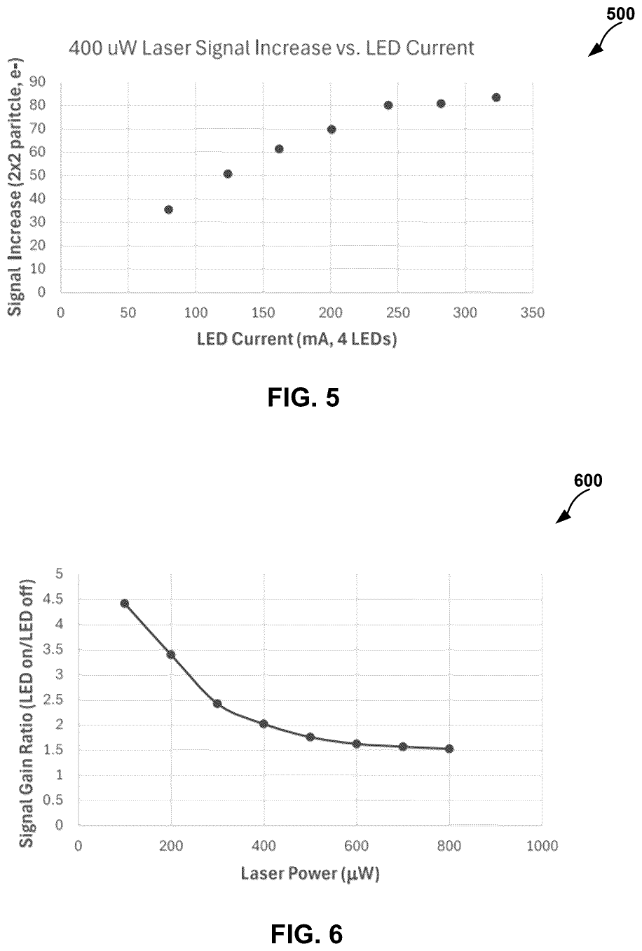

In some examples, the amount of upconversion efficiency increase and/or gain may depend on the amount of signal light 116, e.g., the amount of upconversion efficiency increase and/or gain for a given amount of pump light 120 may decrease and/or asymptote off for higher amounts of signal light 116. FIG. 6 is an example plot 600 illustrating signal light 116 gain ratio (e.g., a ratio of the amount of signal light 116 converted to detection light 118 and detected by silicon substrate 101 with pump light 120 on versus with pump light 120 off) as a function of the amount of signal light 116, e.g., shown as a SWIR laser output power along the x-axis of plot 600, in accordance with techniques of the present disclosure. In the example shown, the signal gain ratio decreases with increase signal light 116, and asymptotes off to a substantially constant gain ratio for larger signal light 116 amounts. For example, the benefit of pump light 120 increases with decreasing signal light 116 amounts.

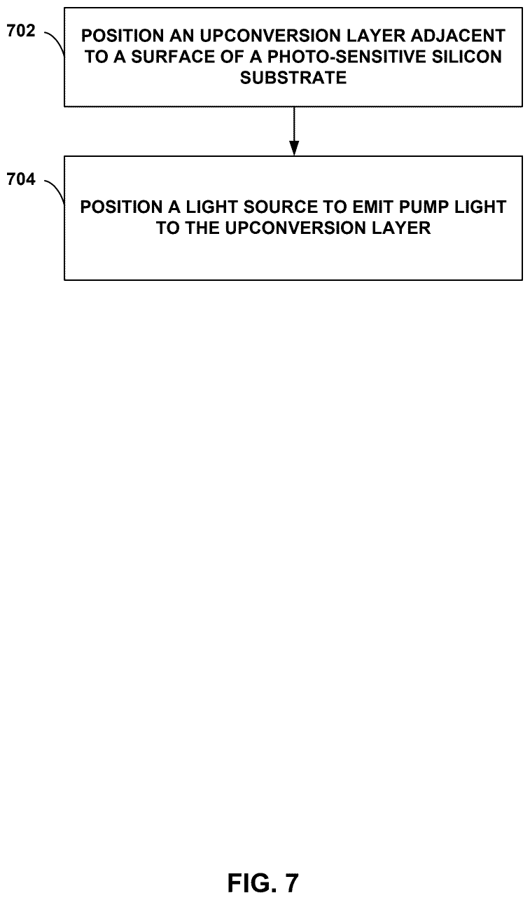

FIG. 7 is a flowchart of an example method of making a sensor, in accordance with techniques of the disclosure. Although the method is described with reference to systems 100, 150, and 400 and sensors 101, 151 of FIGS. 1-6, the methods discussed herein may include and/or utilize other systems and methods in other examples.

A manufacturer may position an upconversion layer 104 adjacent to a surface of a photo-sensitive silicon substrate 102 (702). In some examples, the manufacturer may position upconversion layer 104 adjacent to silicon substrate 102 in a backside illuminated configuration (FIG. 1A) or a top side illuminated configuration (FIG. 2A). In some examples, upconversion layer 104 may be configured to convert electromagnetic radiation comprising a first range of wavelengths (e.g., signal light 116) to electromagnetic radiation comprising a second range of wavelengths (e.g., detection light 118) by a two-photon transition of energy states of atoms of a plurality of crystals 110 of upconversion layer 104. In some examples, the manufacturer may position upconversion layer 104 adjacent to a surface of the photo-sensitive silicon substrate 102 by disposing the upconversion layer 104 on, and in contact with, a surface of the photo-sensitive silicon substrate 102, or on and in contact with a layer (e.g., a primer layer, bonding, or binding layer) that is on and in contact with the surface of the photo-sensitive silicon substrate 102.

The manufacturer may position a light source 112 to emit electromagnetic radiation comprising the first range of wavelengths (e.g., pump light 120) to the upconversion layer 104 (704). In some examples, the manufacturer may position the light source so as to not obstruct a clear aperture of sensor 101 of system 100, or sensor 151 of system 150, from receiving electromagnetic radiation comprising a first range of wavelengths (e.g., signal light 116) from a scene external to the sensor 101, 151. In some examples, light source 112 is configured to increase a population of the atoms of the plurality of crystals 110 excited to an intermediate energy state |a> of the two-photon transition.

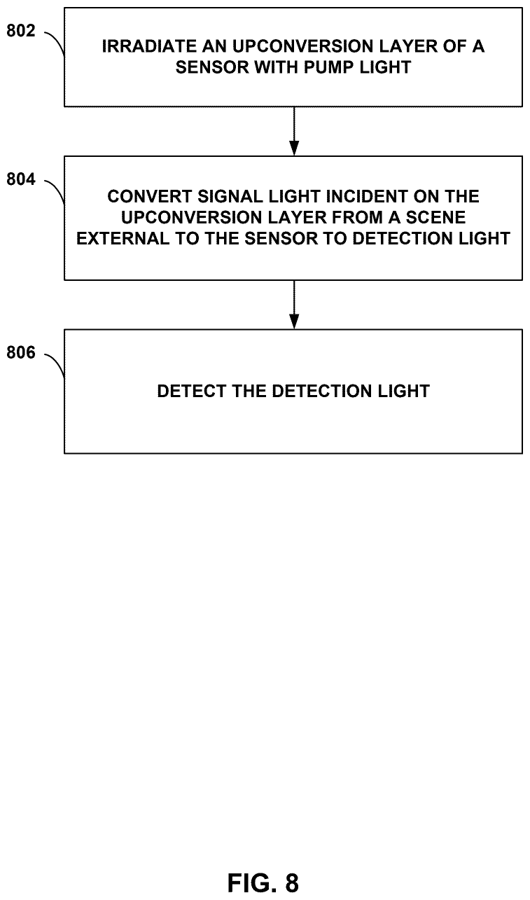

FIG. 8 is a flowchart of an example method of detecting electromagnetic radiation, in accordance with techniques of the disclosure. Although the method is described with reference to systems 100, 150, and 400 and sensors 101, 151 of FIGS. 1-6, the methods discussed herein may include and/or utilize other systems and methods in other examples.

A computing device 420 may cause a light source 112 to irradiate an upconversion layer 104 of the sensor 101 with pump light 120 comprising a first range of greater than 1100 nm wavelengths (802). The upconversion layer 104 may convert signal light 116 comprising the first range of wavelengths incident on the upconversion layer 104 and from a scene external to the sensor 101 to detection light 118 comprising the second range of wavelengths (804). Sensor 101 may detect, by silicon substrate 102, detection light 118 comprising the second range of wavelengths (806). In some examples, computing device 420 may then change the amount of pump light 120 comprising the first range of wavelengths emitted by light source 112 to the upconversion layer 104 based on the amount of signal light 116 comprising the first range of wavelengths from the scene. For example, computing device 420 may cause light source 112 to irradiate upconversion layer 104 with an amount of pump light 120 such that shot noise just begins to increase.

The cost of short wave infrared (SWIR) imagers and/or laser designators may be high due to materials and processing, there is a need for low-cost SWIR imagers. Described herein are silicon CMOS and CCD or other imagers that can increase SWIR upconversion efficiency, and in some examples the SWIR quantum efficiency (QE), for increased distance ranging (e.g., for LiDAR systems), and in some examples, increased night vision capability and extend silicon imager response to SWIR wavelengths. The disclosed low cost systems and sensors (e.g., systems 100, 150, 400 and sensors 101, 151) may be silicon imagers with a relatively low cost crystal layer (e.g., crystals 110) applied such that it interacts with incoming photons and upconverts the wavelength of the incoming photons. The systems and sensors disclosed include 1500 nm, 1535 nm, 1550 nm, 2000 nm, 2600 nm, or other SWIR wavelength LIDAR laser or laser designators. Additionally, the SWIR response of example sensors disclosed herein may allow a silicon device to image in the wavelength range of eye safe layers used for target designation, communications, and LiDAR. Example sensors disclosed here may be a low-cost solution to SWIR sensing, detection, and/or imaging, e.g., relative to InGaAs detectors with a readout integrated circuit (IC) and an attached detector array.

For the disclosed crystal upconversion layer 104, the crystals 110 may be applied in a light transmitting medium to the front (e.g., top) or back (e.g., bottom) side of silicon imagers such as CMOS or CCD. This may not require silicon processing and can be added after wafers are delivered from a silicon foundry. Applying these layers may not increase dark current, which is useful for low light level imaging. The addition of the upconverting layer 104 may not increase system size weight or power. The described methods and configurations may reduce and/or eliminate the need for specialized silicon foundry processing. Aspects of the techniques herein may be done outside the foundry. This increases the number of foundries available to fabrication and reduces costs.

Furthermore, the disclosed approach may be applicable to top side illumination (TSI) and back side illuminated (BSI) CMOS and CCD imaging arrays. The application of the crystals 110 may be done after silicon foundry steps are completed. The completed device may be monolithic in that detector bumping may be not required as may be for other approaches.

A sensor array using sensors disclosed herein may be useful for threat detection and identification of eye safe and non-eye safe laser designators overlaid on a scene image showing the field of view. A VIS/NIR image may be able to provide night vision while allowing the user to see laser designators on a remote target, with an improved distance range for low laser designator light levels.

The foregoing system and embodiments thereof have been provided in sufficient detail, but it may be not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

The following are examples of one or more aspects of the disclosure:
Example 1: A sensor includes: an upconversion layer including a plurality of crystals configured to convert electromagnetic radiation including a first range of wavelengths greater than 1100 nm to electromagnetic radiation including a second range of wavelengths less than or equal to 1100 nm; a photo-sensitive silicon substrate configured to detect the electromagnetic radiation including the second range of wavelengths; and a light source configured to emit electromagnetic radiation including the first range of wavelengths to the upconversion layer.
Example 2: The sensor of example 1, wherein the plurality of crystals include a dopant configured to absorb the electromagnetic radiation including the first range of wavelengths and emit the electromagnetic radiation including the second range of wavelengths.
Example 3: The sensor of example 2, wherein the dopant includes a rare-earth element.
Example 4: The sensor of any one of examples 1 through 3, wherein the upconversion layer is configured to convert electromagnetic radiation including the first range of wavelengths to electromagnetic radiation including the second range of wavelengths by a two-photon transition of energy states of atoms of the plurality of crystals, wherein the light source is configured to increase a population of the atoms of the plurality of crystals excited to an intermediate energy state of the two-photon transition.
Example 5: The sensor of any one of examples 1 through 4, wherein the electromagnetic radiation including the first range of wavelengths includes at least one of 1535 nanometer (nm) light, 1550 nm light, 2000 nm light, or 2600 nm light, wherein electromagnetic radiation including the second range of wavelengths includes at least one of 980 nm light or 1020 nm light.
Example 6: The sensor of any of one examples 1 through 5, wherein the upconversion layer including the plurality of crystals is underlying the photo-sensitive silicon substrate.
Example 7: The sensor of example 6, further including a reflector underlying the upconversion layer including a plurality of crystals, wherein the reflector is configured to reflect the electromagnetic radiation comprising the second range of wavelengths.
Example 8: The sensor of example 6 or example 7, wherein the light source is configured to emit electromagnetic radiation including the first range of wavelengths to the upconversion layer through the photo-sensitive silicon substrate.
Example 9: The sensor of example 8, wherein the photo-sensitive silicon substrate is configured to substantially transmit the electromagnetic radiation including the first range of wavelengths.
Example 10: The sensor of any one of examples 1 through 9, wherein the light source is configured to emit the electromagnetic radiation including the first range of wavelengths to the upconversion layer from an off-axis angle with respect to an axis that is perpendicular to a surface of the photo-sensitive silicon substrate.
Example 11: The sensor of example 10, wherein the light source is configured to emit the electromagnetic radiation including the first range of wavelengths to the upconversion layer and such that the electromagnetic radiation including the first range of wavelengths emitted by the light source does not exit the sensor without being upconverted.
Example 12: The sensor of any one of examples 1 through 11, wherein the sensor defines a clear aperture configured to allow electromagnetic radiation comprising the first range of wavelengths emitted or reflected by an object in a scene external to the sensor to be incident on the upconversion layer, wherein the light source is configured to not obstruct the clear aperture.
Example 13: The sensor of example 12, wherein the light source configured to emit the electromagnetic radiation including the first range of wavelengths with a substantially constant irradiance over a surface area of the upconversion layer.
Example 14: The sensor of any one of examples 1 through 13, further including a wavelength filter disposed between the light source and the upconversion layer, the wavelength filter configured to pass the electromagnetic radiation including a first range of wavelengths and at least one of reduce or block electromagnetic radiation not including the first range of wavelengths.
Example 15: A method of making a sensor, the method including: positioning an upconversion layer adjacent to a surface of a photo-sensitive silicon substrate, wherein the upconversion layer includes a plurality of crystals, wherein the plurality of crystals are configured to convert electromagnetic radiation including a first range of wavelengths greater than 1100 nm to electromagnetic radiation including a second range of wavelengths less than or equal to 1100 nm, wherein the photo-sensitive silicon substrate is configured to detect the electromagnetic radiation including the second range of wavelengths; and positioning a light source to emit electromagnetic radiation including the first range of wavelengths to the upconversion layer, wherein the light source is positioned to not obstruct a clear aperture of the sensor from receiving electromagnetic radiation including a first range of wavelengths from a scene external to the sensor.
Example 16: The method of example 15, wherein the upconversion layer is configured to convert electromagnetic radiation including a first range of wavelengths to electromagnetic radiation including a second range of wavelengths by a two-photon transition of energy states of atoms of the plurality of crystals, wherein the light source is configured to increase a population of the atoms of the plurality of crystals excited to an intermediate energy state of the two-photon transition.
Example 17: The method of example 15 or example 16, wherein the electromagnetic radiation including the first range of wavelengths includes at least one of 1535 nanometer (nm) light, 1550 nm light, 2000 nm light, or 2600 nm light, wherein electromagnetic radiation including the second range of wavelengths includes at least one of 980 nm light or 1020 nm light.
Example 18: The method of any one of examples 15 through 17, wherein positioning the upconversion layer adjacent to the surface of the photo-sensitive silicon substrate includes disposing the upconversion layer on a surface of the photo-sensitive silicon substrate.
Example 19: A method of detecting electromagnetic radiation, the method including: irradiating, by a light source, an upconversion layer of a sensor with a first electromagnetic radiation comprising a first range of wavelengths greater than 1100 nm; converting, by the upconversion layer, a second electromagnetic radiation comprising the first range of wavelengths and incident on the upconversion layer from a scene external to the sensor to electromagnetic radiation comprising the second range of wavelengths; and detecting, by a photo-sensitive silicon substrate of the sensor, the electromagnetic radiation comprising the second range of wavelengths.
Example 20: The method of example 19, further including: changing, based on an amount of the second electromagnetic radiation, an amount of the first electromagnetic radiation from the light source to irradiate the upconversion layer.

The techniques described in this disclosure may be implemented, at least in part, in hardware, software, firmware, or any combination thereof. For example, various aspects of the techniques may be implemented within one or more microprocessors, DSPs, ASICs, FPGAs, or any other equivalent integrated or discrete logic QRS circuitry, as well as any combinations of such components, embodied in external devices. The terms “processor” and “processing circuitry” may generally refer to any of the foregoing logic circuitry, alone or in combination with other logic circuitry, or any other equivalent circuitry, and alone or in combination with other digital or analog circuitry. In some examples, processing circuitry, such as processing circuitry 416, may be monolithically built on silicon substrate 102.

For aspects implemented in software, at least some of the functionality ascribed to the systems and devices described in this disclosure may be embodied as instructions on a computer-readable storage medium such as RAM, DRAM, SRAM, magnetic discs, optical discs, flash memories, or forms of EPROM or EEPROM. The instructions may be executed to support one or more aspects of the functionality described in this disclosure.

In addition, in some respects, the functionality described herein may be provided within dedicated hardware and/or software modules. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components. Also, the techniques may be fully implemented in one or more circuits or logic elements.

What is claimed is:

1. A sensor comprising:
an upconversion layer comprising a plurality of crystals configured to convert electromagnetic radiation comprising a first range of wavelengths greater than 1100 nm to electromagnetic radiation comprising a second range of wavelengths less than or equal to 1100 nm;
a photo-sensitive silicon substrate configured to detect the electromagnetic radiation comprising the second range of wavelengths; and
a light source configured to emit electromagnetic radiation comprising the first range of wavelengths to the upconversion layer.

2. The sensor of claim 1, wherein the plurality of crystals comprise a dopant configured to absorb the electromagnetic radiation comprising the first range of wavelengths and emit the electromagnetic radiation comprising the second range of wavelengths.

3. The sensor of claim 2, wherein the dopant comprises a rare-earth element.

4. The sensor of claim 1, wherein the upconversion layer is configured to convert electromagnetic radiation comprising the first range of wavelengths to electromagnetic radiation comprising the second range of wavelengths by a two-photon transition of energy states of atoms of the plurality of crystals, wherein the light source is configured to increase a population of the atoms of the plurality of crystals excited to an intermediate energy state of the two-photon transition.

5. The sensor of claim 1, wherein the electromagnetic radiation comprising the first range of wavelengths comprises at least one of 1535 nanometer (nm) light, 1550 nm light, 2000 nm light, or 2600 nm light, wherein electromagnetic radiation comprising the second range of wavelengths comprises at least one of 980 nm light or 1020 nm light.

6. The sensor of claim 1, wherein the upconversion layer comprising the plurality of crystals is underlying the photo-sensitive silicon substrate.

7. The sensor of claim 6, further comprising a reflector underlying the upconversion layer comprising a plurality of crystals, wherein the reflector is configured to reflect the electromagnetic radiation comprising the second range of wavelengths.

8. The sensor of claim 6, wherein the light source is configured to emit electromagnetic radiation comprising the first range of wavelengths to the upconversion layer through the photo-sensitive silicon substrate.

9. The sensor of claim 8, wherein the photo-sensitive silicon substrate is configured to substantially transmit the electromagnetic radiation comprising the first range of wavelengths.

10. The sensor of claim 1, wherein the light source is configured to emit the electromagnetic radiation comprising the first range of wavelengths to the upconversion layer from an off-axis angle with respect to an axis that is perpendicular to a surface of the photo-sensitive silicon substrate.

11. The sensor of claim 10, wherein the light source is configured to emit the electromagnetic radiation comprising the first range of wavelengths to the upconversion layer and such that the electromagnetic radiation comprising the first range of wavelengths emitted by the light source does not exit the sensor without being upconverted.

12. The sensor of claim 1, wherein the sensor defines a clear aperture configured to allow electromagnetic radiation comprising the first range of wavelengths emitted or reflected by an object in a scene external to the sensor to be incident on the upconversion layer, wherein the light source is configured to not obstruct the clear aperture.

13. The sensor of claim 12, wherein the light source configured to emit the electromagnetic radiation comprising the first range of wavelengths with a substantially constant irradiance over a surface area of the upconversion layer.

14. The sensor of claim 1, further comprising a wavelength filter disposed between the light source and the upconversion layer, the wavelength filter configured to pass the electromagnetic radiation comprising a first range of wavelengths and at least one of reduce or block electromagnetic radiation not comprising the first range of wavelengths.

15. A method of making a sensor, the method comprising:
positioning an upconversion layer adjacent to a surface of a photo-sensitive silicon substrate,
wherein the upconversion layer comprises a plurality of crystals, wherein the plurality of crystals are configured to convert electromagnetic radiation comprising a first range of wavelengths greater than 1100 nm to electromagnetic radiation comprising a second range of wavelengths less than or equal to 1100 nm,
wherein the photo-sensitive silicon substrate is configured to detect the electromagnetic radiation comprising the second range of wavelengths; and
positioning a light source to emit electromagnetic radiation comprising the first range of wavelengths to the upconversion layer, wherein the light source is positioned to not obstruct a clear aperture of the sensor from receiving electromagnetic radiation comprising a first range of wavelengths from a scene external to the sensor.

16. The method of claim 15, wherein the upconversion layer is configured to convert electromagnetic radiation comprising a first range of wavelengths to electromagnetic radiation comprising a second range of wavelengths by a two-photon transition of energy states of atoms of the plurality of crystals, wherein the light source is configured to increase a population of the atoms of the plurality of crystals excited to an intermediate energy state of the two-photon transition.

17. The method of claim 15, wherein the electromagnetic radiation comprising the first range of wavelengths comprises at least one of 1535 nanometer (nm) light, 1550 nm light, 2000 nm light, or 2600 nm light, wherein electromagnetic radiation comprising the second range of wavelengths comprises at least one of 980 nm light or 1020 nm light.

18. The method of claim 15, wherein positioning the upconversion layer adjacent to the surface of the photo-sensitive silicon substrate comprises disposing the upconversion layer on a surface of the photo-sensitive silicon substrate.

19. A method of detecting electromagnetic radiation, the method comprising:
irradiating, by a light source, an upconversion layer of a sensor with a first electromagnetic radiation comprising a first range of wavelengths greater than 1100 nm;
converting, by the upconversion layer, a second electromagnetic radiation comprising the first range of wavelengths and incident on the upconversion layer from a scene external to the sensor to electromagnetic radiation comprising the second range of wavelengths; and
detecting, by a photo-sensitive silicon substrate of the sensor, the electromagnetic radiation comprising the second range of wavelengths.

20. The method of claim 19, further comprising:
changing, based on an amount of the second electromagnetic radiation, an amount of the first electromagnetic radiation from the light source to irradiate the upconversion layer.
